(19) United States
(12) Patent Application Publication
(10) Pub. No.: US 2017/0348075 A1
(43) Pub. Date: Dec. 7, 2017

(54) HEAT MOLDABLE, MULTILAYER DENTURE

(71) Applicants: Lindsey E. Otero, Hampstead, NC (US); Misael J. Otero, Hampstead, NC (US); Richard C. Albers, Wilmington, NC (US)

(72) Inventors: Lindsey E. Otero, Hampstead, NC (US); Misael J. Otero, Hampstead, NC (US); Richard C. Albers, Wilmington, NC (US)

(21) Appl. No.: 15/176,148

(22) Filed: Jun. 7, 2016

(51) Int. Cl. A61C 13/107; A61C 13/01; A61C 13/00; A61C 13/08; A61C 13/20

(52) U.S. Cl. CPC A61C 13/0001; A61C 13/08; A61C 13/20; A61C 13/0024; A61C 13/01; A61C 2201/00

(57) ABSTRACT

A universal fit, boil-and-bite denture may be sold over-the-counter. The denture includes a first portion that includes a tooth and a second portion attached to the first portion, the second portion comprising heat moldable material. The second portion may be configured to be formed in a mouth of a user when the user bites down on the heat moldable material. A multilayered (e.g., three layered) denture includes an expandable palate. When a palate portion expands, deforms or otherwise adjusts, a dental occlusion of the denture is maintained. The denture may be manufactured using injection molding or other layered manufacturing techniques.

### CROSS REFERENCE TO RELATED APPLICATIONS

This application is a continuation application and claims priority from U.S. Provisional Patent Application No. 62/042,048, filed on Aug. 13,2015; U.S. Provisional Patent Application No. 62/213,106, filed on Sep. 2, 2015; U.S. Provisional Patent Application No. 62/238,955, filed on Nov. 28, 2015, and U.S. Provisional Patent Application No. 62/302,195, filed on Mar. 2, 2016, which are incorporated herein by reference in their entireties.

### FIELD OF THE DISCLOSURE

The present disclosure relates generally to dentures and processes for making the same.

### BACKGROUND

Dentures are removable plates or frames that hold artificial teeth. Denture manufacturing is conventionally driven by a dentist for an individual patient. The dentist works in concert with a laboratory to have individually manufactured teeth pressed in to wax, which is melted out and replaced with resin. The patient is typically fit multiple times with the denture. Each fitting can involve sending the denture back to the laboratory for additional adjustment.

While effective at restoring a patient's ability to chew and smile confidently, the denture manufacturing process can be expensive and time consuming. For those with limited financial means or access to oral care professionals, the expense and complex process can impede the potential benefits of dentures. Lastly, there are individuals who do not visit the dentist.

### SUMMARY OF THE DISCLOSURE

According to an embodiment, an apparatus includes a first portion comprising a tooth and a second portion attached to the first portion, the second portion comprising heat moldable material, such as thermoplastic material.

In an illustrative implementation, the second portion is configured to be softened in hot water. The second portion may be configured to be formed in a mouth of a user when the user bites down on the heat moldable material. The second portion may be configured to fit a plurality of different mouth sizes. In an example, the second portion is injection molded. The apparatus thus comprises a universal fit, boil-and-bite denture. The boil-and-bite denture may be sold over-the-counter or by a dentist. The apparatus may comprise one of a plurality of standard, differently sized dentures

An embodiment of a method of manufacturing a denture includes forming a first portion comprising a tooth and forming a second portion comprising heat moldable material. The first portion is attached to the second portion.

According to a particular embodiment, an apparatus includes a first layer comprising a tooth and a first second layer attached to the first layer. At least one of the first layer and the second layer are injection molded.

The second layer of an embodiment is configured to be formed to fit the mouth of a user (e.g., by boiling and enabling the user to bite into the second layer). The second layer is configured to harden in between one and ten minutes. The second layer is configured to be reformed by repeating the heating (e.g., boiling).

A particular embodiment of a method of manufacturing a denture includes forming a first layer comprising a tooth and forming a second layer. The first layer and the second layer are attached, and at least one of the first layer and the second layer are injection molded.

According to another particular embodiment, an apparatus includes a tooth portion comprising a tooth and a palate portion connected to, in communication with, or proximate to the tooth portion. The palate portion includes an adjustable surface area.

In an implementation, the palate portion includes at least one of: a contoured surface, an accordion design, a tongue-shaped design, a jagged surface, a smooth surface, a flexible surface, a foldable surface, a perforated surface, an actuating surface, an expanding surface, and a changeable surface. The surface, for instance, may be changed to contact and contour to patient tissue. The palate portion is configured to be at least one of: expanded, contracted, flexed, folded, and moved in such a manner as to change the surface area of the palate portion. The tooth portion includes a plurality of teeth in addition to the tooth, the teeth having an occlusion, and wherein the occlusion may be maintained as the surface area is adjusted. The palate portion includes at least one of a channel, a cut, or other design element that is cut or formed to facilitate adjustment of the surface area. The palate portion includes at least one of a channel, a cut, or other design element that is cut or formed to facilitate adjustment of the surface area. The adjustable surface area of the palate portion is adjustable in a direction that includes at least one of vertical and horizontal.

According to a particular method of manufacturing a denture, a tooth portion is formed. The method includes forming a palate portion to have an adjustable surface area.

An apparatus of an example includes a tooth and an injection molded portion attached to the tooth. An embodiment of a method includes manufacturing a denture by injection molding a portion of the denture and attaching a tooth to the portion.

According to another particular implementation, an apparatus includes a first layer comprising a tooth and a second layer attached to the first layer. The second layer comprises a portion having an adjustable surface area.

In an implementation, a third layer is positioned between or proximate the first and second layers. The second layer is formable at temperatures ranging between 120 degrees Fahrenheit and 180 degrees Fahrenheit. In another example, the second layer is formable at temperatures ranging between 140 degrees Fahrenheit and 240 degrees Fahrenheit. The second layer includes excess material that may be trimmed.

In one embodiment, all three layers may be connected to one another directly. In another embodiment, one of the layers may be connected directly to one other layer, but not another. For instance, a tooth layer may be proximate to or in communication with a gingival layer, but may not be connected directly to a gingival layer.

A particular of manufacturing a denture includes forming a first layer comprising a tooth and forming a second layer attached to the first layer. The second layer includes a portion having an adjustable surface area.

Features and other benefits that characterize embodiments are set forth in the claims annexed hereto and forming a further part hereof. However, for a better understanding of the embodiments, and of the advantages and objectives attained through their use, reference should be made to the Drawings and to the accompanying descriptive matter.

### BRIEF DESCRIPTION OF THE DRAWINGS

FIG. 1 shows a perspective view of an embodiment of a universal fit, boil-and-bite, multilayered, upper denture having an expandable palate;

FIG. 2 shows a bottom view of an embodiment of a universal fit, boil-and-bite, multilayered upper denture having an expandable palate portion;

FIG. 3 shows a top view of an embodiment of a universal fit, boil-and-bite, multilayered upper denture having an expandable palate portion;

FIG. 4 shows a side, rear view of an embodiment of a universal fit, boil-and-bite, multilayered upper denture having an expandable palate portion;

FIG. 5 shows a side, front view of an embodiment of a universal fit, boil-and-bite, multilayered upper denture having an expandable palate portion;

FIG. 6 shows a view of an embodiment of a universal fit, boil-and-bite, multilayered bottom denture; and

FIG. 7 is a flowchart outlining an embodiment of a method of manufacturing a denture using injection molding processes.

### DETAILED DESCRIPTION

An embodiment of a denture system includes an over-the-counter or dentist supplied product that allows a denture to feel and function similar to a traditional denture. The denture may be fitted quickly and conveniently at home or at a dentist's office just similar to a boil-and-bite mouthpiece. When boiled in water, the denture molds and flexes to take most mouth shapes. Differently sized dentures (e.g., small, medium, large, etc.) may be sold to accommodate different mouth sizes and various shapes, generally. The composition stiffens or hardens in the patient's mouth or cool water in around one to ten minutes and will maintain its shape. Where desired, the denture may be re-heated to take another shape or to adjust to changes in a palate over time. The injection molding processes enables cost efficient mass production.

A feature includes an adjustable palate area that has the ability to expand, contract, flex, and/or move in such a manner as to change the inherent surface area of a palate portion so that material is not the only variable that can adapt to the various shapes of human palates. As such, a particular embodiment includes a flexible, adaptable palate that uses folded, flexible, expanding, or otherwise changing surface area properties to adapt to the top surface of a mouth. The palate design may include a contoured surface, such as an accordion design, a tongue-shaped design, an alternating, jagged surface, or any other non-smooth, flexible, or actuating designs.

The palate portion is designed to expand its surface area with a uniform or non-geodesic disruptive, contiguous, or non-contiguous surface that can expand and/or collapse using a variety of different configurations and designs. The surface area of the palate may expand using techniques that include but are not limited to cross-sections or lateral sections that look like speed bumps, pointed/non-pointed arches, radial circles or other shapes, accordion design, expandable or retractable levers or tongues, church steeple or rounded radius design, contoured or non-contoured to accomplish the ability to move material selectively to sections of the mouth that need fitting. The number of features, frequency used, and combination may vary across different embodiments. When the palate portion is heated, becomes pliable, and comes in contact with the upper part of the mouth, the denture may be pushed, molded, and/or moved to expand or reduce in size to contour to the shape of a mouth of a user.

An implementation may be mass produced using injection molding processes to produce an over-the counter-denture available for home or dentist fitting and with or without a prescription. The denture is moldable and may be shaped with heating. The denture may further be reshaped after setting. The moldable denture system may include multiple layers (e.g., at least two layers). An expandable palate portion (e.g., comprising a gingival and/or liner layer) of the denture may move up, down, or horizontally to accommodate different palatal vaults. The palatal vault design may move independently without moving the teeth out of alignment. As such, the independently shapeable palate may preserve the occlusion while expanding or contracting. Occlusion for purposes of this disclosure refers to a physical relationship between teeth. For instance, occlusion may refer to a relationship between maxillary (upper) and mandibular (lower) teeth as they approach each other.

A user may have a work time often minutes or less before hardening. The cooled denture is functional and maintains its shape. Embodiments of dentures allow users to eat without requiring the expensive process of creating standard dentures for patients at the dental office. The dentures are able to fit nearly any size and shape mouth by virtue of the material, design, size, and palate design.

Embodiments include an acrylic that is injection moldable, but after curing and hardening, the acrylic material can be shaped and formed by applying minimal heat, e.g., between 140-240 degrees Fahrenheit. In a specific example, deformation of the denture begins at around 180 degrees Fahrenheit and becomes completely malleable when exposed to 220 degrees Fahrenheit for 30 seconds. The temperature of the denture may not increase beyond a malleable threshold in a manner analogous to a phase change boiling point.

Once cooled, the acrylic material retains its shape in the hardened form. Custom formable dentures may accommodate wide ranges of mouth dimensions. Once cured, the molded denture retains its shape. The users can also reshape the denture at a later point in time, if desired. The material may also be sold as sheets or in other forms that can be bent to apply structural supports for various applications such as splints, more durable mouth guards, sleep apnea devices, retainers, etc.

In practice, the dentures may allow a user to have one to ten minutes of working time after boiling to shape the dentures to their mouth. After boiling, dentures may take up to about five minutes to set. According to an implementation, enough material may be included as to allow the users to trim any excess, depending on how much they need to fit properly and comfortably.

The dentures may be created through injection molding, over molding, three-dimensional (3-D) printing, or other layered manufacturing processes to create layers that comprise the denture. While embodiments may include two or more layers, an illustrative denture may have three layers. The first layer may include teeth that are shot into a mold. The teeth may be formed in one piece using injection molded, white acrylic.

The second layer, or gingival layer, may include a gingival layer that is over molded (e.g., molded) onto the teeth. The gingival layer may include injection molded pink acrylic. A third layer, or liner layer, may include a cushioning liner that is molded onto the gingival layer. The third layer may comprise a relatively soft layer. At least the liner layer, and in some embodiments the gingival layer, may stretch to get suction and form to fit the mouth of the user (e.g., their palate).

Channels, cuts, folds, or other design elements may be made or formed into the expanding layer(s). The design elements and layers may allow the layer(s) to stretch side-to-side, as well as up and down. The denture system thus provides a boil-and-bite method that allows thermoplastic resin and stretch to conform to different mouth shapes.

During manufacture, a powder and liquid are mixed in ratio. The mixture hardens and may be pelletized. The pellets may be put into an injection molding machine. Layer one may be injection molded into a first layer tool (e.g., a white teeth layer). A second layer (e.g., a pink gingival layer) may be deposited over the first layer. A third layer (e.g., a liner layer) may be injection molded onto the second layer. A slider mechanism may slide over or around any one of the layers.

As discussed herein, a cut, channel or other design element may be made into one or more of the denture layers. This feature may enable the palate portion of the denture (e.g., comprising part one or more top layers) to expand or otherwise change dimensions that may not significantly affect the occlusion of the teeth layer. When a user stretches the palate, that portion stretches while the rest of the dimensions may be maintained. If palate of a user is relatively deep, the user may manipulate the material to reach the user's palate tissue. For instance, a user may push up on the palate portion of the denture to stretch it upwards towards the palate tissue. Alternatively, if the palate is shallow, the user may push less. The layer(s) may be stretched to accommodate shallow, wide or narrow palates.

In this manner, the denture enables a user to change a surface area of a palate portion with or without changing an occlusion (e.g., shifting of teeth). The stretched material then cools to a desired hardness. The teeth may be made wide or narrow to match the mouth of a user without changing the palate.

In use, a patient may use a slotted spoon to place and remove an upper or lower denture into the hot water for 30-120 seconds. The patient may slide their thumb up to hold denture at roof of their mouth. They may use their fingers to push the denture firmly against their tissue. If the front teeth protrude more than desired, the patient may push them back. The patient may close their mouth and use a swallowing technique to create suction while pushing their thumb towards roof of mouth, for 90 seconds. The patient attempts to create a tight seal between denture and the roof of their mouth accomplished by swallowing to create suction. Once complete, the denture may be placed into a bowl of cold water for 10 seconds or more to set. The process may be repeated if a good fit is not initially achieved. Similar processes may be used for both upper and lower dentures.

In practice, an apparatus comprises a universal fit, boil-and-bite denture that may be sold over-the-counter or used in a dental office. The apparatus includes a first portion comprising a tooth and a second portion attached to the first portion, the second portion comprising heat moldable material. The second portion may be configured to be formed in a mouth of a user when the user bites down on the heat moldable material. A multilayered denture includes an expandable palate. While a palate portion expands or otherwise deforms, a dental occlusion of the denture may be maintained. The denture may be manufactured using injection molding processes.

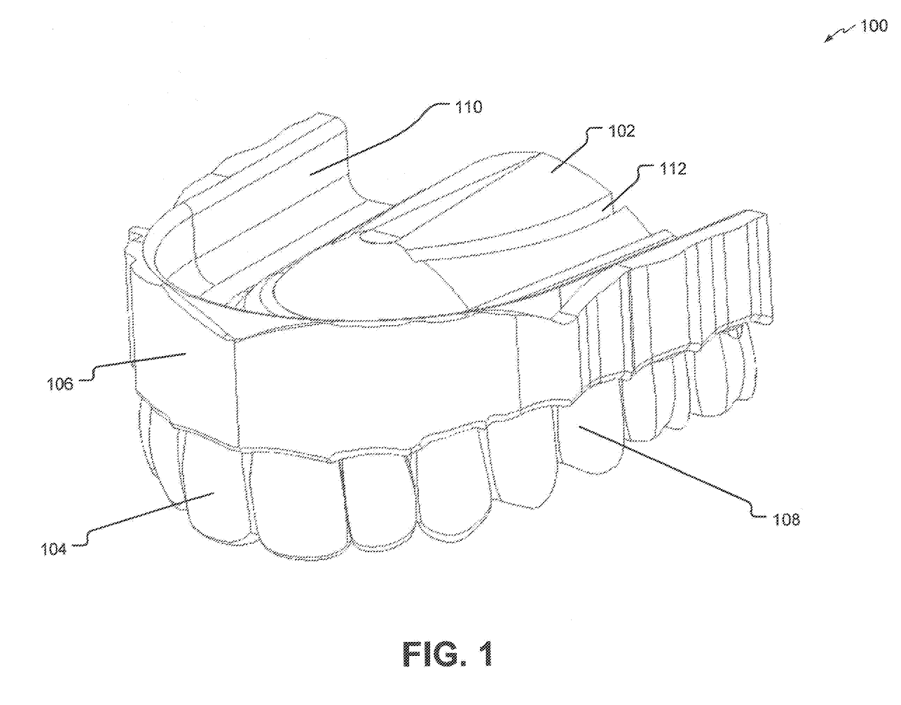

FIG. 1 shows a perspective view of a universal fit, boil-and-bite, multilayered, upper denture 100 having an expandable palate. A palate portion 102 expands, raises, lowers, shifts, or otherwise deforms, while a tooth portion 108 may be maintained. The denture 100 of the same or another embodiment may be manufactured using injection molding processes.

A first layer 104, or tooth layer, may be molded over with a second layer 106, or gingival layer. The teeth 108 of the first layer 104 may all be connected and become slightly pliable under heat.

The second layer 106 (e.g., gingival portion) may be pliable when heated, as the gingival portion flexes to fit shape and angles of the user's mouth. A third layer 110, or liner layer, may include a conformable, cushioning material to ensure a comfortable fit, as well as to be used to create suction to a palate of a user. At least one of the second layer 106 and the third layer 110 may be designed to accommodate varying mouth sizes. To this end, at least one of the second layer 106 and the third layer 110 may include slits, folds, or other design elements 112 that allow the third layer 110 to adjust the surface area of the palate portion 102. The conformable strip of the liner layer becomes pliable when heated and conforms to voids in the ridgeline or other tissue of a user. This portion fills in small features not accommodated by the second layer 106. The third layer 110 may be designed to harden after molding to the mouth of the user or may remain soft.

Out of the box, the dentures of an embodiment are hard like standard dentures, but once submerged in boiling water for around 30 to 120 seconds, the dentures become flexible to form to the user's mouth. After about 1-10 minutes of setting with or without submerging in cool water, the dentures maintain their shape and harden. If at some point later on the user desires to refit the dentures, they can easily re-boil the dentures and form to their mouth again.

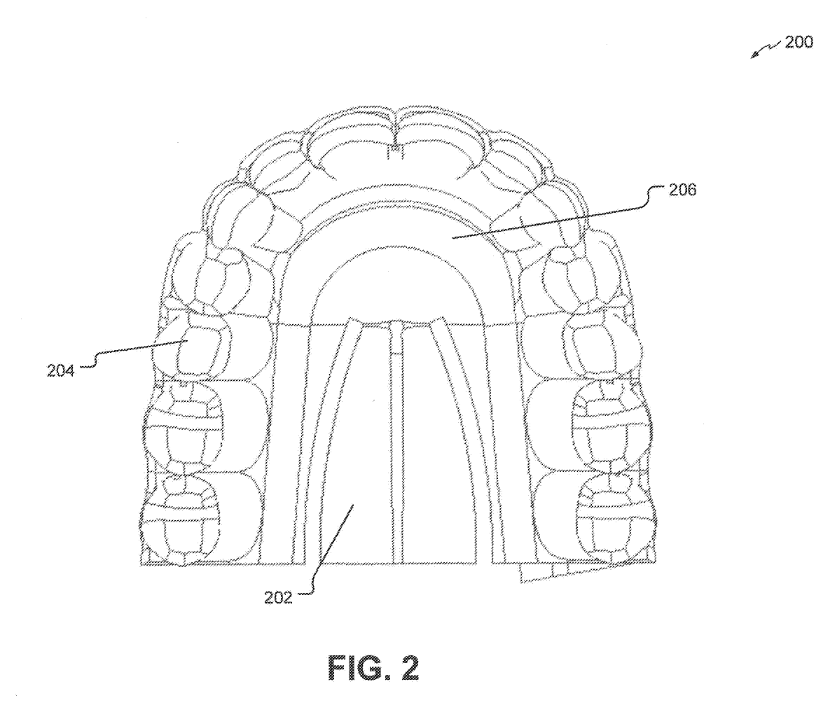

FIG. 2 shows a bottom view of a universal fit, boil-and-bite, multilayered upper denture 200 having an expandable portion 202. A tooth layer 204 is attached to a gingival layer 206 that includes the expandable palate portion 202. The denture 200 may be similar to or the same as that shown in FIG. 1. In another embodiment, a third layer (not shown) may Include an expandable portion, in addition or as an alternative to the gingival layer 206. The expandable palate portion 202 of the denture 200 may move up or down and/or side-to-side without affecting the occlusion of the tooth layer 204.

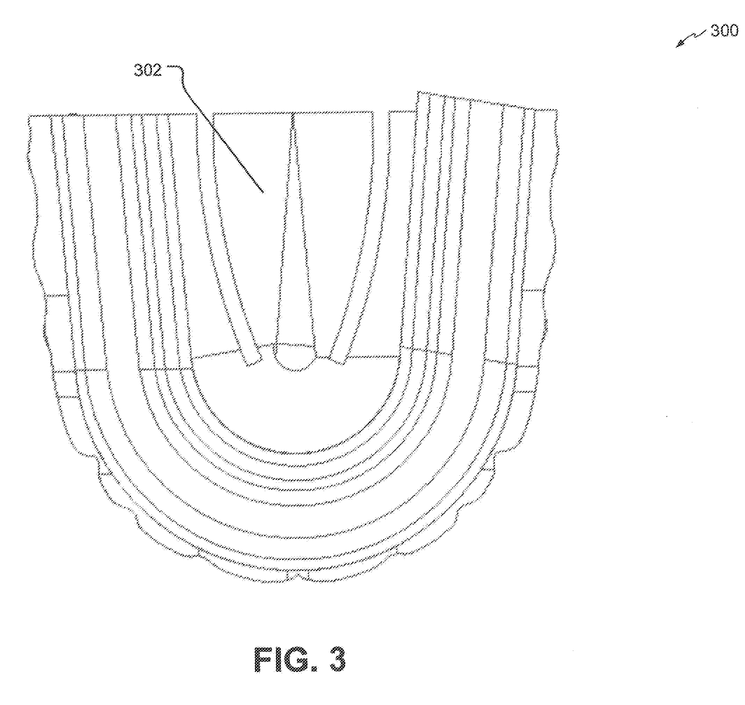

FIG. 3 shows a top view of a universal fit, boil-and-bite, multilayered upper denture 300 having an expandable palate portion 302. Slits or other design elements 304 may be formed in the palate portion 302. The palate portion may comprise one or both of a gingival layer and a liner layer. The denture 300 may be similar to or the same as those shown in FIGS. 1 and 2.

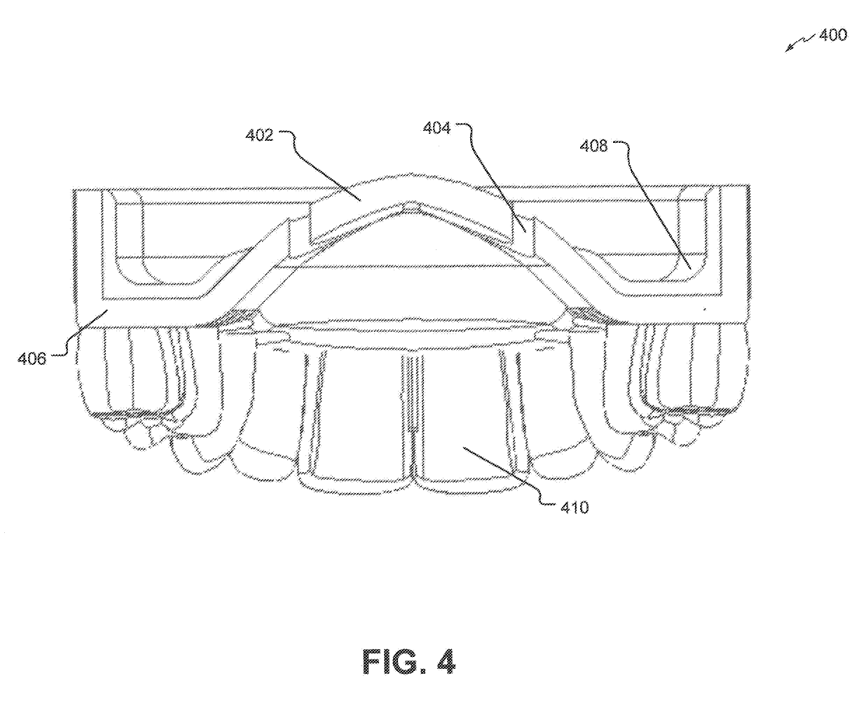

FIG. 4 shows a rear view of a universal fit, boil-and-bite, multilayered upper denture 400 having an expandable palate portion 402. The expandability may be enabled by slits 404 that are cut, molded, or otherwise formed in the denture 400. The slits 404 may be formed in either or both a gingival layer 406 and an EVA/liner layer 408. The denture 400 may be similar to or the same as those shown in FIGS. 1-3. The expandable palate portion 402 of the denture 400 may move up or down to accommodate different palatal vaults. The palate portion 402 may move independently without affecting the occlusion of the tooth layer 410.

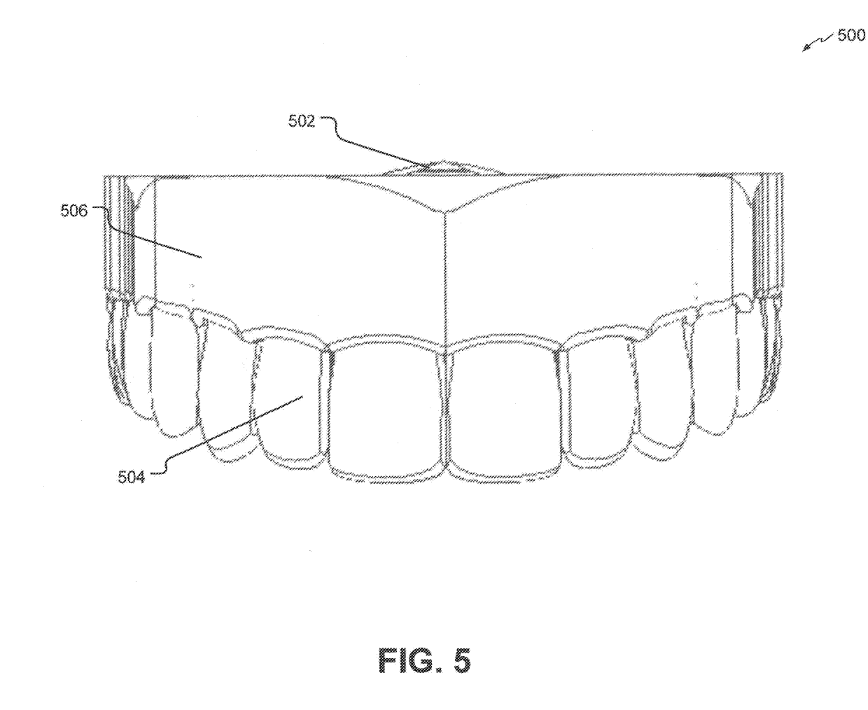

FIG. 5 shows a front view of a universal fit, boil-and-bite, multilayered upper denture 500 having an expandable palate portion 502. The denture 500 may be similar to or the same as those shown in FIGS. 1-4. A first layer 504 (e.g. a tooth layer) is shown attached to a second layer 506 (e.g., a gingival layer). A third layer (not shown), such a as a liner layer) is optionally included in the embodiment.

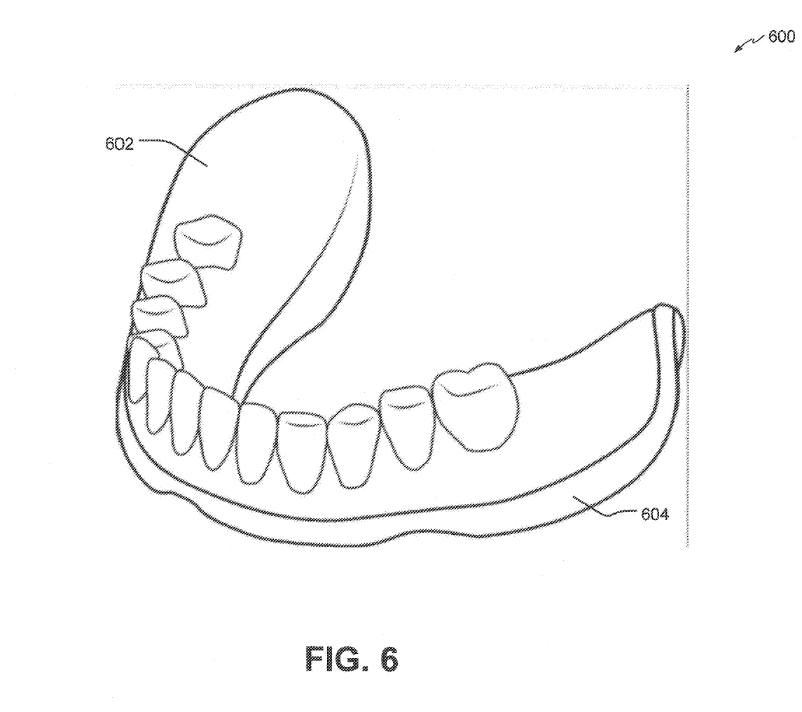

FIG. 6 shows a view of an embodiment of a universal fit, boil-and-bite, multilayered bottom denture 600. The denture 600 may be used alone or in combination with an upper denture, such as any of those illustrated in FIGS. 1-5. The manufacture and composition of the denture 600 may be similar to those of the upper dentures described herein, including the inclusion of multiple layers 602,604.

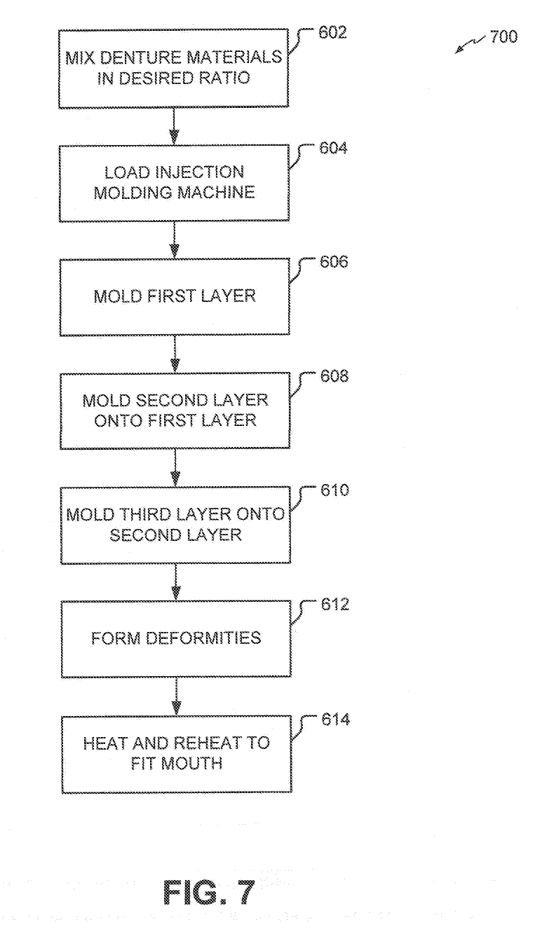

FIG. 7 is a flowchart outlining an embodiment of a method of manufacturing a denture using injection molding processes. The denture may be created through injection molding with overmolding to create layers that comprising the denture. An illustrative denture may have three layers.

During manufacture by injection molding, a powder and liquid are mixed in ratio at 702. The mixture may include a plasticizer. The mixture hardens and is pelletized. The pellets are put into an injection molding machine at 704.

Layer one may be injection molded at 706 into a first layer tool (e.g., a white teeth layer). The first layer may include teeth that are shot into a mold. The teeth may be formed in one piece using injection molded, white acrylic. A second layer may be deposited on the first layer (e.g., a pink gingival layer), A third layer (e.g. a pink liner layer), may be injection molded onto the second layer at 710.

Channels, cuts, folds, contours, or other design elements may be cut or formed (e.g., molded) at 712 into the expanding layer(s). The design elements and layers may allow the layer(s) to stretch side-to-side, as well as up and down. The adaptable palate may use folded, flexible, expanding, or otherwise changing surface area properties to adapt to the top surface of a mouth. The palate design may include a contoured surface, such as an accordion design, a tongue-shaped design, an alternating, jagged surface, or any other non-smooth, flexible, or actuating designs.

The denture is moldable and can be shaped at 714 with heating. The denture may further be reshaped after setting by reintroducing the denture to boiling water and repeating the boil-and-bit process.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

1-7. (canceled)

8. A method of manufacturing a denture, the method comprising:
molding a first portion comprising a tooth; and
molding a second portion comprising heat moldable material, wherein the first portion is attached to the second portion.

9-12. (canceled)

13. A method of manufacturing a denture, the method comprising:
forming a first layer comprising a tooth;
forming a second layer; and
attaching the second layer to the first layer, wherein at least one of the first layer and the second layer are created using a layered manufacturing process comprising at least one of injection molding or three-dimensional printing.

14. A method of manufacturing a denture, the method comprising:
forming a first portion comprising a tooth; and
forming a second portion attached to the first portion, the second portion comprising heat moldable material; and
forming the shape of the second portion within a mouth of a user, wherein no further adjustments are required for wearing.

15. The method of claim 14, further comprising softening the second layer in hot liquid.

16. The method of claim 14, wherein the user manipulates the second portion to fit their mouth.

17. The method of claim 14, wherein the second portion is configured to fit a plurality of different mouth sizes.

18. The method of claim 14, wherein the second portion is generated using a layered manufacturing process.

19. The method of claim 14, wherein the apparatus is a universal fit, boil-and-bite denture, wherein the method forms one of a plurality of standard, differently sized dentures.

20. The method of claim 14, wherein the apparatus is sold over-the-counter without a prescription.

21. A method of manufacturing a denture, the method comprising:
providing a first layer comprising a tooth;
providing a second layer attached to the first layer, wherein at least one of the first layer and the second layer are created using a layered manufacturing process; and
forming the second layer by pressing the second layer in an upwards direction into a roof of a mouth of a user, wherein forming the second layer includes deforming the second layer.

22. The method of claim 21, further comprising expanding the second layer.

23. The method of claim 22, allowing the second layer to harden in between one and ten minutes.

21. The method of claim 21, wherein the second layer is configured to be reformed and refitted using heat.

25. The method according to claim 13, wherein both of the first layer and the second layer are created using the layered manufacturing process.
